(19) United States
(12) Patent Application Publication
(10) Pub. No.: US 2016/0061628 A1
(43) Pub. Date: Mar. 3, 2016

(54) APPARATUS AND METHOD FOR CORRECTING GYRO SENSOR

(71) Applicant: SAMSUNG ELECTRO-MECHANICS CO., LTD., Suwon-si (KR)

(72) Inventors: Kyung Rin KIM, Suwon-si (KR); Byoung Won HWANG, Suwon-si (KR); Chang Hyun KIM, Suwon-si (KR)

(73) Assignee: SAMSUNG ELECTRO-MECHANICS CO., LTD., Suwon-si (KR)

(21) Appl. No.: 14/679,245

(22) Filed: Apr. 6, 2015

(30) Foreign Application Priority Data
Sep. 1, 2014 (KR) 10-2014-0115620

(51) Int. Cl. G01C 25/00

(52) U.S. Cl. CPC G01C 25/005

(57) ABSTRACT

There is provided an apparatus for correcting a gyro sensor, including: a driving circuit using a driving displacement signal from the gyro sensor and a reference voltage to output a demodulated signal; a correction circuit determining whether a duty ratio of the demodulated signal is distorted and performing a correction to converge the duty ratio of the demodulated signal to a preset target value if it is determined that the duty ratio of the demodulated signal is distorted; and a sensing circuit performing a demodulation process of a sensing signal from the gyro sensor using the demodulated signal to output a gyro signal, whereby it is possible to accurately detect the gyro signal so as to assure reliability of the gyro sensor.

### CROSS-REFERENCE TO RELATED APPLICATION

This application claims the benefit of Korean Patent Application No. 10-2014-0115620, filed on Sep. 1, 2014, entitled “Apparatus And Method For Correcting Gyro Sensor” which is hereby incorporated by reference in its entirety into this application.

### BACKGROUND

The present disclosure relates to an apparatus and a method for correcting a gyro sensor.

A gyro sensor, which is a sensor detecting angular velocity, has been mainly used in an attitude control of an aircraft, a rocket, a robot, and the like, a hand vibration compensation of a camera, a binocular, and the like, an automobile sliding and rotating prevention system, navigation, and the like. Generally, the gyro sensor has been released, mounted in recently developing mobile devices.

Various gyro sensors are sensors which detect a torque quantity of an object to measure an angular velocity of the corresponding object. The angular velocity may be obtained by Coriolis force “F=2 mΩV”, in which m represents a mass of a sensor mass, Ω represents an angular velocity to be measured, and V represents a motion velocity of the sensor mass.

FIG. 1 illustrates a principle of detecting an angular velocity of a gyro sensor. When a mass of a sensor resonates in an X direction and a torque is applied in a Z direction, a Coriolis force is generated in a Y direction to convert the corresponding signal into an electrical signal, the converted signal is subjected to a predetermined signal processing process to detect an inertial force for the angular velocity from a control circuit of the gyro sensor.

The generated Coriolis force is generally modulated into a driving displacement signal of the mass of the gyro sensor, which is in turn applied to a sensing circuit. The sensing circuit performs a demodulation process to remove the driving displacement signal and detects only a signal using an inertial input. Here, a demodulated signal used during the demodulation process is generated by a comparator of the driving circuit which receives the driving displacement signal from the gyro sensor. To accurately detect the Coriolis force which is applied in the modulated state, an accurate demodulated signal without distortion is required.

That is, accuracy of the demodulated signal is one of very important factors in signal processing of the gyro sensor to accurately detect the angular velocity. However, the demodulated signal may be distorted due to various causes in the signal processing of the circuit and a situation in which the gyro signal may not be detected accurately due to the corresponding distortion may often occur.

### RELATED ART DOCUMENT

### Patent Document

(Patent Document 2) JP2004-212111 A

### SUMMARY

An aspect of the present disclosure may determine whether a duty ratio of a demodulated signal output from a comparator is distorted in signal processing of a gyro sensor. Another aspect of the present disclosure may provide an apparatus and a method for correcting a gyro sensor capable of correcting a distortion of a duty ratio of a demodulated signal by adjusting a reference voltage of a comparator generating the demodulated signal, when the duty ratio of the demodulated signal is distorted.

According to an aspect of the present disclosure, an apparatus for correcting a gyro sensor, may include: a driving circuit using a driving displacement signal from the gyro sensor and a reference voltage to output a demodulated signal; a correction circuit determining whether a duty ratio of the demodulated signal is distorted by comparing an integral value calculated by integrating the demodulated signal with a preset reference value and adjusting a reference voltage to converge the duty ratio of the demodulated signal to a preset target value if it is determined that the duty ratio of the demodulated signal is distorted; and a sensing circuit performing a demodulation process of a sensing signal from the gyro sensor using the demodulated signal to output a gyro signal.

According to another aspect of the present disclosure, a method for correcting a gyro sensor may include: a driving step of generating a demodulated signal based on a driving displacement signal of the gyro sensor and a reference voltage; a correction step of determining whether a duty ratio of the demodulated signal is distorted by integrating the demodulated signal and a correction step of adjusting the reference voltage to converge the duty ratio of the demodulated signal to the preset target value if it is determined that the duty ratio of the demodulated signal is distorted; and a sensing step of outputting the gyro signal using a demodulation process of the demodulated signal and a sensing signal from the gyro sensor.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating a principle of detecting an angular velocity of a gyro sensor;

FIG. 2 is a block diagram of an apparatus for correcting a gyro sensor according to an exemplary embodiment of the present disclosure;

FIG. 3 is a diagram illustrating the overall system of the apparatus for correcting a gyro sensor according to the exemplary embodiment of the present disclosure;

FIGS. 4A-D and 5A-D are diagrams illustrating a demodulation process in a sensing process of the gyro sensor;

FIG. 6 is a diagram illustrating the demodulation process when a duty ratio of a demodulated signal is distorted;

FIG. 7 is a diagram illustrating a process of determining whether the duty ratio of the demodulated signal is distorted, by integrating the demodulated signal;

FIG. 8 is a diagram illustrating a process of correcting the demodulated signal by adjusting a reference voltage; and

FIG. 9 is a diagram illustrating a method for correcting a gyro sensor according to an exemplary embodiment of the present disclosure.

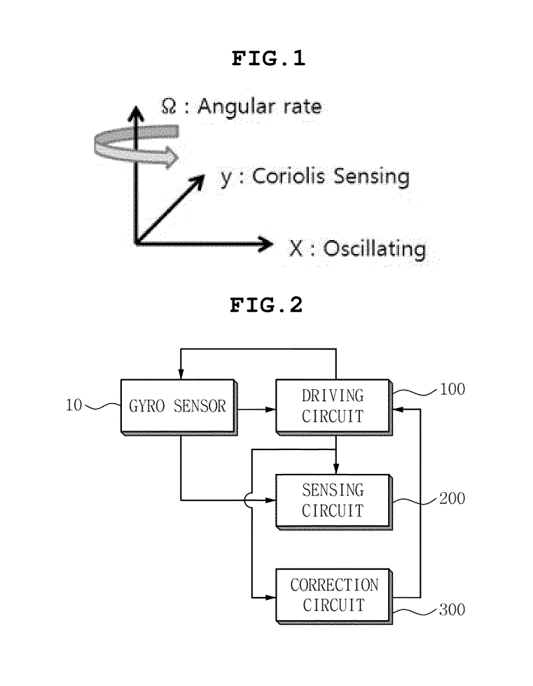

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

Hereinafter, exemplary embodiments of the present disclosure will be described in detail with reference to the accompanying drawings, in which a driving displacement signal, a sensing signal, a demodulated signal, a control signal, and a gyro signal may be represented by a voltage form or a current form.

As illustrated in FIG. 2, an apparatus for correcting a gyro sensor 10 according to an exemplary embodiment of the present disclosure includes the gyro sensor 10 including at least one driving mass, a driving circuit 100 receiving the driving displacement signal to generate the driving signal and the demodulated signal, a sensing circuit 300 outputting the gyro signal based on the sensing signal, and a correction circuit 200 determining whether a duty ratio of the demodulated signal is distorted and performing a correction to remove the distortion.

Here, the distortion of the demodulated signal may occur due to various causes such as a distortion of a signal input to a comparator 103, a parasitic component of a circuit, an error of a reference voltage of the comparator 103, and a transmission of a delayed signal. It is difficult to accurately detect only the gyro signal in a demodulation process to be described below, due to the occurring distortion.

Therefore, a correction to determine whether the demodulated signal is distorted and remove the distortion when the demodulated signal is distorted is performed. As a result, the gyro sensor 10 may detect only the accurate gyro signal component to assure reliability of the gyro sensor 10 and improve performance of devices in which the gyro sensor 10 is equipped.

The gyro sensor 10 is a sensor which includes a driving mass (not illustrated) to be able to detect three axial angular velocities which are positioned on a space. A driving signal in a pulse wave form which is applied from a driving circuit 100 vibrates a driving mass (not illustrated) and a driving displacement signal in a sine wave form is generated by the vibration.

Here, a resonance condition of the driving mass (not illustrated) by the driving signal is that a phase difference between the driving signal and the driving displacement signal should be 90° and when the driving mass resonates, even though a size of a driving signal is small, the driving mass (not illustrated) much moves, thereby obtaining the driving displacement signal having a large size.

The driving circuit 100 generates the demodulated signal and the driving signal based on the driving displacement signal output from the gyro sensor 10. The demodulated signal is used in a demodulation process to remove a driving displacement signal component of the sensing signal modulated by the sensing circuit 300 and the driving signal is a signal which is applied to the gyro sensor 10 to stably resonate the driving mass. The driving signal may have a pulse wave form, but is not necessarily limited thereto. The driving circuit 100 includes a first charge amplifier 101, a phase shifter 102, a comparator 103, and a pulse generator 104 which will be described below in detail.

The sensing circuit 300 performs a series of processes using the sensing signal output from the gyro sensor 10 to detect only the gyro sensor. In detail, the gyro signal and the driving displacement signal are modulated and the sensing signal output from the gyro sensor 10 suffers from the demodulation process using the demodulated signal output from the driving circuit 100 to detect only the gyro signal. The sensing circuit 300 includes a second charge amplifier 301, a demodulator 302, a low pass filter (LPF) 303, and an A/D converter 304 which will be described below in detail.

The correction circuit 200 determines whether the demodulated signal is distorted and when the demodulated signal is distorted, corrects the demodulated signal to remove the distortion. In detail, the correction circuit 200 determines whether a duty ratio of the demodulated signal is distorted and if it is determined that the duty ratio of the demodulated signal is distorted, serves to perform a correction to converge the duty ratio of the demodulated signal to a preset target value. The correction circuit 200 includes a processor 210 and a reference voltage controller 220 which will be described below in detail.

Here, the duty ratio means a numerical value which is represented by a ratio of pulse width PW to pulse period T (PW/T). Further, the target value is a value which is preset by a user. According to an exemplary embodiment of the present disclosure, the target value may be set to be 50%. However, the duty ratio is not necessarily limited to 50% and therefore may be changed by the user to be able to reach other ratios. The detailed description thereof will be provided below.

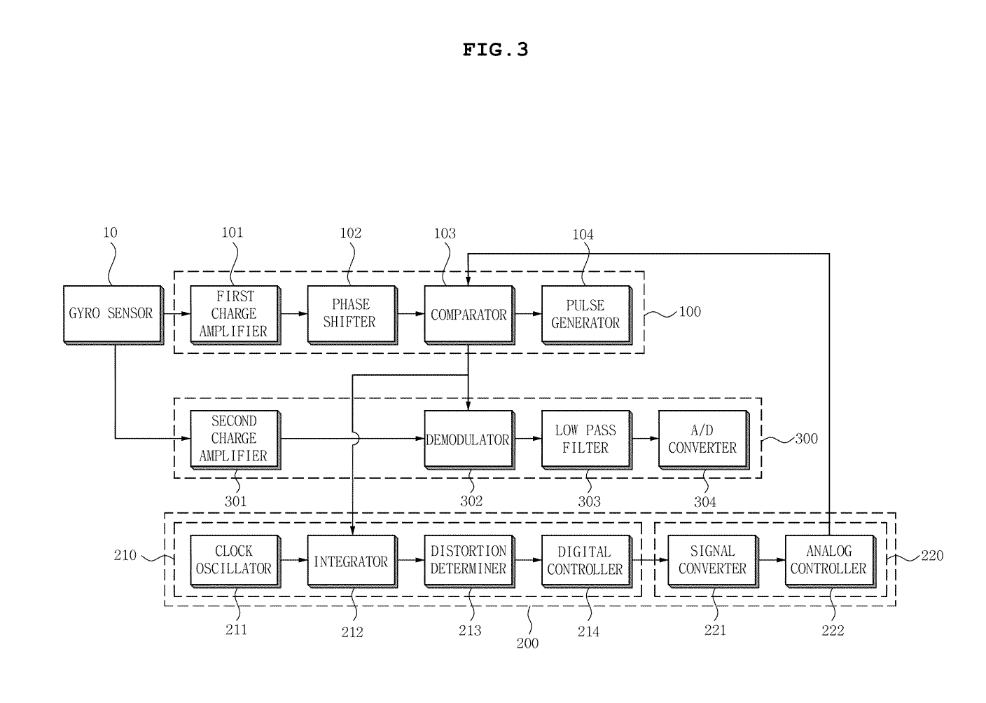

As illustrated in FIG. 3, the driving circuit 100 includes the first charge amplifier 101 converting the driving displacement signal output from the gyro sensor 10 into a voltage signal form, the phase shifter 102 shifting a phase of the output signal from the first charge amplifier 101 by 90°, the comparator 103 comparing the output signal from the phase shifter 102 with the reference voltage to generate the demodulated signal, and the pulse generator 104 generating the driving signal based on the period of the demodulated signal.

The first charge amplifier 101 converts the driving displacement signal, which represents a change in a charge quantity generated from the driving electrode (not illustrated) of the gyro sensor 10, into the voltage form and amplifies the converted driving displacement signal to generate the driving displacement signal in the voltage form. The generated driving displacement signal in the voltage form is transmitted to the phase shifter 102.

The phase shifter 102 serves to delay the phase of the driving displacement signal in the voltage form, which is output from the first charge amplifier 101, by 90° This is to stably resonate the driving mass (not illustrated) of the gyro sensor 10 to generate the driving signal having a phase difference of 90° from the phase of the driving displacement signal.

The comparator 103 compares the output signal from the phase shifter 102 having a phase difference of 90° from the phase of the driving displacement signal with the reference voltage to generate the demodulated signal. In detail, the output signal from the phase shifter 102 is connected to a non-inversion terminal of the comparator 103 and the reference voltage is connected to an inversion terminal of the comparator 103.

The comparator 103 generates the demodulated signal (pulse wave form) having a high value when the output signal from the phase shifter 102 is larger than the reference voltage and generates the demodulated signal (pulse wave form) having a low value when the output signal from the phase shifter 102 is smaller than the reference voltage. The demodulated signal generated from the comparator 103 is transmitted to a demodulator 302 which is included in the sensing circuit 300 and an integrator 212 which is included in the correction circuit 200, respectively, and thus is used for the demodulation process to be described below and the determination on whether the distortion occurs.

Further, the reference voltage of the comparator 103 varies by a control of the correction circuit 200. Therefore, as the reference voltage of the comparator 103 varies, a section having the high value and a section having the low value are changed. As a result, it is possible to control the duty ratio of the demodulated signal by adjusting the reference voltage.

The pulse generator 104 generates the driving signal in the pulse wave form having the same period as that of the demodulated signal and transmits the driving signal to the gyro sensor 10. The driving signal is used while the driving mass of the gyro sensor 10 resonates. Therefore, the driving signal is generated based on the driving displacement signal output from the gyro sensor 10 and therefore a constant phase is formed in the driving circuit 100, such that the driving mass of the gyro sensor 10 may be driven to stably resonate.

As illustrated in FIG. 3, the sensing circuit 300 performs the demodulation process of the sensing signal from the gyro sensor 10 using the demodulated signal to output the gyro signal. Further, the sensing circuit 300 includes the second charge amplifier 102 converting the driving displacement signal output from the gyro sensor 10 into the voltage signal form, a demodulator 302 performing the demodulation process of mixing the output signal from the second charge amplifier 102 with the demodulated signal, the low pass filter 303 removing a high frequency component of the output signal from the demodulator 302, and the A/D converter 304 converting the output signal from the low pass filter 303 into a digital signal form.

The second charge amplifier 102 converts the sensing signal representing the change in the charge quantity generated from the sensing electrode (not illustrated) of the gyro sensor 10 into the voltage signal form and amplifies the converted sensing signal to output the sensing signal in the voltage form. In this case, the sensing signal has a phase difference of 90° from the driving displacement signal output from the first charge amplifier 101.

The demodulator 302 performs the demodulation process of detecting only the gyro signal in the modulated sensing signal. In detail, the demodulator 302 receives the demodulated signal transmitted from the comparator 103 and the modulated sensing signal to mix the demodulated signal with the sensing signal, thereby detecting only the gyro signal. The detected gyro signal is transmitted to the low pass filter 303.

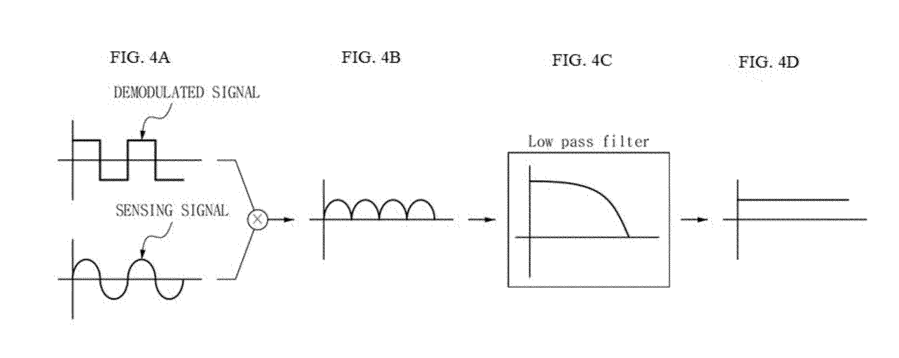

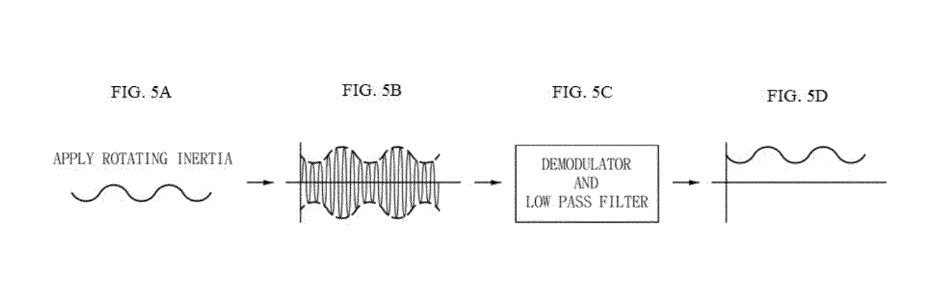

FIGS. 4A to 4D are diagrams illustrating the demodulated process, in which FIG. 4A illustrates the demodulated signal in a pulse wave form which is output from the comparator 103 and the sensing signal in a sine wave form in which an angular velocity is not applied to the gyro sensor 10. Each demodulated signal and sensing signal is input to the demodulator 302 and suffers from a process of mixing the demodulated signal by the sensing signal to output a signal having a waveform as illustrated in FIG. 4B. Next, when an output signal from the demodulator 302 passes through the low pass filter 303 illustrated in FIG. 4C to remove the high frequency component, the gyro signal having a form as illustrated in FIG. 4D is detected.

FIGS. 5A to 5D are diagrams illustrating the demodulation process when a rotating inertia (FIG. 5A) is applied to the gyro sensor 10. FIG. 5B illustrates the driving displacement signal and the sensing signal of which the angular velocity component is modulated. FIG. 5C illustrates that the modulated sensing signal is input to the demodulator 302, suffers from the demodulation process of being mixed with the demodulated signal as described above, and is then input to the low pass filter 303 to detect the gyro signal in an analog form as illustrated in FIG. 5D.

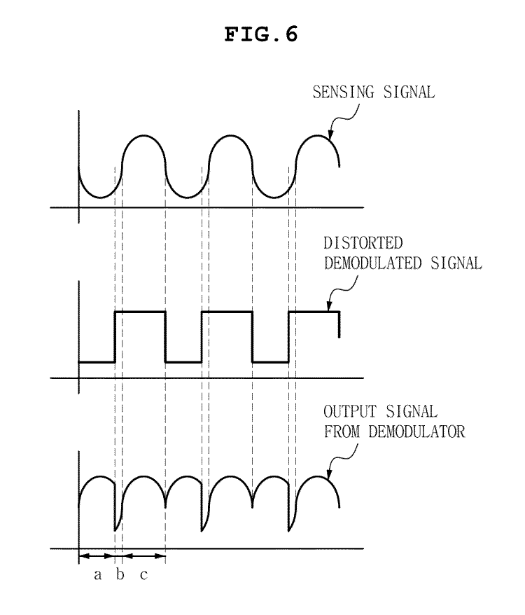

FIG. 6 is a diagram illustrating the output signal from the demodulator 302 generated when the sensing signal and the distorted demodulated signal are input to the demodulator 302. As illustrated in FIG. 6, the distorted duty ratio of the demodulated signal is not 50% and the demodulated signal is a signal having a positive region larger than a negative region. As illustrated in FIG. 6, when the demodulated signal of which the duty ratio is distorted is input, a normal signal is output in sections a and c but the distorted signal is output in section b. Therefore, the distorted gyro signal is output, which leads to a reduction in reliability of the circuit.

Therefore, to detect only the accurate gyro signal by the signal processing of the gyro sensor 10, it is preferable that the duty ratio of the demodulated signal is 50%.

The low pass filter 303 is a filter which passes the frequency component having a band lower than that of a predetermined frequency and does not pass the frequency component having a higher band and serves to remove the high frequency component included in the output signal from the demodulator 302. This is to output only the accurate gyro signal by preventing pollution due to noise.

As illustrated in FIG. 3, the correction circuit 200 includes the processor 210 which integrates the demodulated signal generated from the comparator 103 to determine whether the duty ratio of the demodulated signal is distorted and generates the digital control signal depending on the integration result and the reference voltage controller 220 which receives the digital control signal to adjust the reference voltage.

In detail, the processor 210 integrates the demodulated signal to compare the calculated integral value with the reference value to determine whether the demodulated signal is distorted and if it is determined that the demodulated signal is distorted, calculates a correction value adjusting the reference voltage to make the integral value equal to the reference value. Further, the processor 210 generates the digital control signal depending on the correction value. The processor 210 includes a clock oscillator 211, an integrator 212, a distortion determiner 213, and a digital controller 214.

The clock oscillator 211 generates a clock signal and transmits the generated clock signal to the integrator 212, which is used to integrate the demodulated signal. Since the clock signal is used to determine resolution which is an increasing unit of a minimum measurement value based on which the integrator 212 may recognize the demodulated signal, as a speed of the clock signal is fast, the integrator 212 may more precisely recognize the demodulated signal to more accurately perform the integration.

The integrator 212 integrates the demodulated signal generated from the comparator 103 to calculate an integral value and then transmits the integral value to the distortion determiner 213. The demodulated signal generated from the comparator 103 is transmitted to the demodulator 302, and at the same time, is transmitted to the integrator 212 and is recognized using the clock signal from the clock oscillator 211.

The distortion determiner 213 receives the integral value of the integrator 212 and then analyzes the received integral value to determine whether the demodulated signal is distorted. In detail, the distortion determiner 213 compares the integral value with the preset reference value to determine that the duty ratio of the demodulated signal is not distorted if it is determined that the integral value coincides with the preset reference value. The distortion determiner 213 determines that the duty ratio of the demodulated signal is distorted if it is determined that the integral value is different from the preset reference value to transmit the integral value to the digital controller 214.

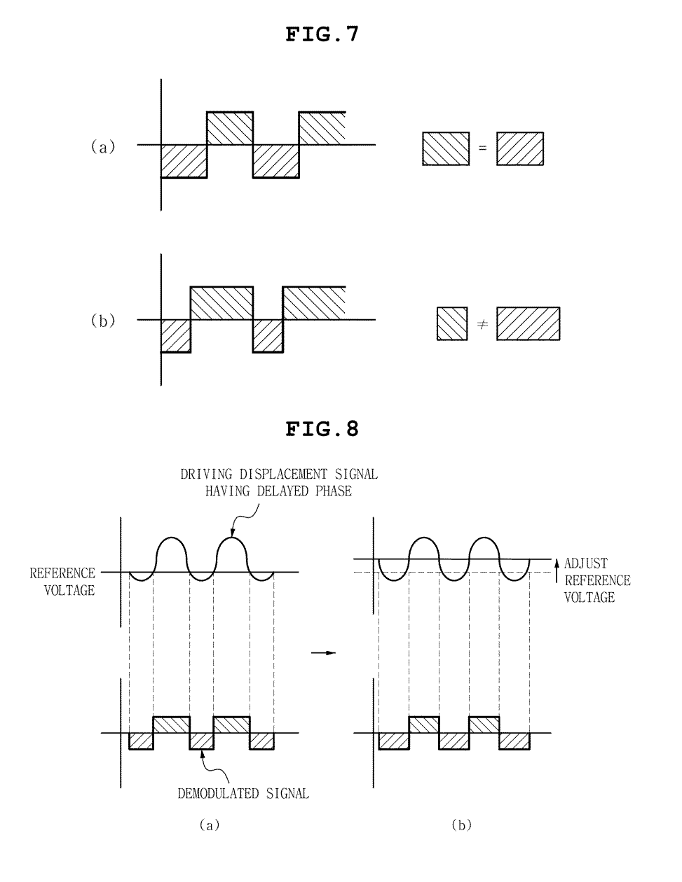

The reference value compared with the integral value is a value set by the user and may be 0 in the exemplary embodiment of the present disclosure. In detail, referring to FIG. 7, when the demodulated signal having the duty ratio of 50% without the distortion is integrated, an area of the positive (+) region is equal to that of the negative (−) region and therefore the integral value becomes 0. However, the reference value is not necessarily limited to 0 and therefore may be different values by the user.

However, since in the distorted demodulated signal (see FIG. 7B), the positive (+) region is larger than the negative (−) region, the integral value has a positive (+) value, not 0. To the contrary, when the negative (−) region is larger than that of the positive (+) region, the integral value has a negative (−) value. That is, if it is determined that the integral value of the integrator 212 is not 0, it may be determined that the duty ratio of the demodulated signal is distorted.

The digital controller 214 calculates the correction value adjusting the reference voltage to make the integral value equal to the reference value and generates the digital control signal corresponding to the calculated correction value. That is, if it is determined that the duty ratio of the demodulated signal is distorted, the digital controller 214 calculates the correction value to make the integral value be a preset reference value, that is, 0 and generates a control signal controlling the reference voltage based on the corresponding correction value.

The reference voltage controller 220 further includes a signal converter 221 which converts the control signal into an analog signal and an analog controller 222 which controls the reference voltage based on the analog signal.

The signal converter 221 converts the digital control signal generated from the digital controller 214 into the analog signal form and transmits the converted digital signal to the analog controller 222. Here, the signal converter 221 may be a digital to analog converter (D/A converter).

The analog controller 222 receives the analog signal output from the signal converter 221 to control the reference voltage of the comparator 103. The analog controller 222 may include an array resistor (not illustrated) which includes at least one resistor and a switch. A resistance value of the array resistor is changed depending on a switching operation and the reference voltage input to the inversion terminal of the comparator 103 is changed with the change in the resistance value and thus the duty ratio of the demodulated signal may be finally controlled.

In detail, as illustrated in FIG. 8, the comparator 103 compares the driving displacement signal delayed by 90° with the reference voltage to generate the demodulated signal. Therefore, when the positive (+) region is larger than the negative (−) region, the duty ratio of the demodulated signal may not be 50% and it may be determined that the distortion occurs. In this case, when the reference voltage is increased than before depending on the analog controller 222, the positive region is reduced and the negative region is increased and thus the duty ratio may reach 50%. To the contrary, when the negative region is smaller than the positive region, a control to lower the reference voltage is performed and thus the distortion of the demodulated signal may be removed.

According to the exemplary embodiment of the present disclosure, when the demodulated signal is distorted due to the parasitic component of the circuit, the delay between the signals, and the like, the correction circuit 200 determines whether the demodulated signal is distorted and corrects the distorted demodulated signal to detect only the accurate gyro signal, thereby improving the reliability of the gyro sensor 10 and the precision of the control.

Hereinafter, a method for correcting a gyro sensor 10 according to the exemplary embodiment of the present disclosure including the above configuration will be described. Hereinafter, the same or similar content as or to the foregoing content will be omitted or briefly described.

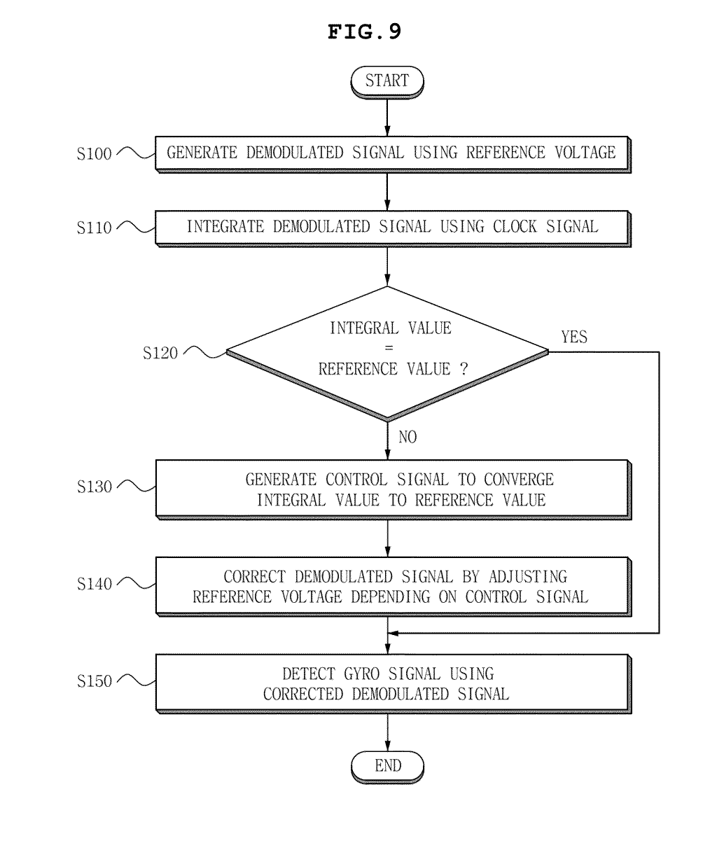

Referring to FIG. 9, the inertia is input to the driving mass (not illustrated) of the gyro sensor 10 and the change in the charge quantity generated from the driving electrode (not illustrated) is converted to the driving displacement signal in the voltage signal form through the first charge amplifier 101. The comparator 103 compares the driving displacement signal having a phase delayed by 90° by the phase shifter 102 with the reference voltage to generate the demodulated signal.

In detail, the demodulated signal is generated by allowing the demodulated signal to have the high value when the driving displacement signal is larger than the reference voltage and the low value when the driving displacement signal is smaller than the reference voltage, by comparing the driving displacement signal delayed by 90° with the reference voltage. The demodulated signal generated from the comparator 103 is transmitted to the demodulator 302 of the sensing circuit 300, the integrator 212 of the correction circuit 200, and the pulse generator 104. The pulse generator 104 receiving the demodulated signal generates the driving signal and applies the generated driving signal to the gyro sensor 10, such that the gyro sensor 10 stably resonates.

Next, a correction step of determining whether the duty ratio of the demodulated signal is distorted and converging the duty ratio of the demodulated signal to the preset target value if it is determined that the distortion occurs is performed.

The correction step includes a step of integrating the demodulated signal to determine whether the duty ratio of the demodulated signal is distorted and generating the digital control signal depending to the integration result if it is determined that the distortion occurs and adjusting the reference voltage depending on the digital control signal.

In detail, the integrator 212 integrates the demodulated signal using the clock signal generated from the clock oscillator 211 (S110). Next, the integral value calculated by the integrator 212 is compared with the preset reference value to determine whether the demodulated signal is distorted and the preset reference value may be 0. If it is determined that the integral value does not coincide with the preset reference value, it is determined that the duty ratio of the demodulated signal is distorted (S120). Next, to perform a correction to converge the integral value to the preset reference value, the correction value is calculated and the digital control signal corresponding to the correction value is generated (S130).

Next, the signal converter 221 converts the digital control signal into the analog control signal and controls the reference voltage based on the analog control signal to remove the distortion so that the duty ratio of the demodulated signal is converged to the target value (S140).

Finally, a sensing step of detecting only the gyro signal using the demodulation process of mixing the sensing signal from the gyro sensor 10 with the demodulated signal is performed (S150). The sensing step includes a step of converting the change in the charge quantity generated from the sensing electrode of the gyro sensor 10 into the voltage signal form, a step of detecting only the gyro signal component from the modulated sensing signal using the mixing of the output signal from the second charge amplifier 102 with the demodulated signal, a step of removing the high frequency component of the output signal from the demodulator 302 using the low pass filter 303, and a step of converting the output signal from the filter 303 into the digital signal form.

As described above, the apparatus for correcting a gyro sensor 10 according to the exemplary embodiment of the present disclosure determines whether the duty ratio of the demodulated signal generated by being compared with the reference voltage by the comparator 103 is distorted by the integrator 212 and the distortion determiner 213 of the correction circuit 200 and if it is determined that the demodulated signal is distorted, adjusts the reference voltage of the comparator 103 by the analog controller 222 to remove the distortion of the demodulated signal, thereby outputting only the accurate gyro signal. As the result, it is possible to assure the reliability and accuracy of the gyro sensor 10 and there is no need to consider various parasitic components which cause the distortions during the manufacturing process.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. An apparatus for correcting a gyro sensor, comprising:
a driving circuit using a driving displacement signal from the gyro sensor and a reference voltage to output a demodulated signal;
a correction circuit determining whether a duty ratio of the demodulated signal is distorted and performing a correction to converge the duty ratio of the demodulated signal to a preset target value if it is determined that the duty ratio of the demodulated signal is distorted; and
a sensing circuit performing a demodulation process of a sensing signal from the gyro sensor using the demodulated signal to output a gyro signal.

2. The apparatus of claim 1, wherein the driving circuit includes:
a first charge amplifier converting the driving displacement signal output from the gyro sensor into a voltage signal form;
a phase shifter shifting a phase of an output signal from the first charge amplifier;
a comparator comparing an output signal from the phase shifter with the reference voltage to generate the demodulated signal; and
a pulse generator generating a driving signal based on the demodulated signal.

3. The apparatus of claim 2, wherein the reference voltage varies by a control of the correction circuit when the distortion of the duty ratio of the demodulated signal occurs.

4. The apparatus of claim 1, wherein the correction circuit includes:
a processor integrating the demodulated signal received from the driving circuit to determine whether the duty ratio of the demodulated signal is distorted and generating a digital control signal depending on the integration result; and
a reference voltage controller receiving the digital control signal to adjust the reference voltage.

5. The apparatus of claim 4, wherein the processor includes:
a clock oscillator generating a clock signal;
an integrator performing an integration process using the clock signal to calculate an integral value of the demodulated signal;
a distortion determiner comparing the integral value with a preset reference value and determining that the duty ratio of the demodulated signal is distorted when the integral value is different from the reference value; and
a digital controller calculating a correction value adjusting the reference voltage to make the integral value equal to the reference value and generating a digital control signal corresponding to the correction value.

6. The apparatus of claim 4, wherein the reference voltage controller includes:
a signal converter converting the digital control signal into an analog control signal; and
an analog controller adjusting the reference voltage based on the analog control signal to converge the duty ratio of the demodulated signal to the target value.

7. The apparatus of claim 6, wherein the signal converter is a digital to analog converter.

8. The apparatus of claim 1, wherein the sensing circuit includes:
a second charge amplifier converting the sensing signal output from the gyro sensor into a voltage signal form;
a demodulator performing a demodulation process of mixing an output signal from the second charge amplifier with the demodulated signal;
a low pass filter removing a high frequency component of an output signal from the demodulator; and
an analog to digital converter converting an output signal from the low pass filter into a digital signal value.

9. A method for correcting a gyro sensor, comprising:
a driving step of generating a demodulated signal based on a driving displacement signal of the gyro sensor and a reference voltage;
a correction step of determining whether a duty ratio of the demodulated signal is distorted and converging the duty ratio of the demodulated signal to a preset target value if it is determined that the duty ratio of the demodulated signal is distorted; and
a sensing step of detecting a gyro signal using a demodulation process of the demodulated signal and a sensing signal from the gyro sensor.

10. The method of claim 9, wherein the driving step includes:
a step of converting the driving displacement signal output from the gyro sensor into a voltage signal form;
a step of shifting a phase of the driving displacement signal in the voltage signal form;
a step of comparing the shifted driving displacement signal with the reference voltage to generate the demodulated signal; and
a step of generating a driving signal based on the demodulated signal.

11. The method of claim 9, wherein the correcting includes:
a digital correction step of integrating the demodulated signal to determine whether the duty ratio of the demodulated signal is distorted and generating a digital control signal depending on the integration result of the demodulated signal if it is determined that the distortion occurs; and
a reference voltage control step of adjusting the reference voltage depending on the digital control signal.

12. The method of claim 11, wherein the digital correction step includes:
a step of generating a clock signal;
a step of integrating the demodulated signal using the clock signal to calculate an integral value;
a distortion determination step of comparing the integral value with a preset reference value and determining that the duty ratio of the demodulated signal is distorted when the integral value is different from the reference value; and
a step of calculating a correction value adjusting the reference voltage to make the integral value equal to the reference value and generating a digital control signal corresponding to the correction value.

13. The method of claim 11, wherein the reference voltage control step includes:
a step of converting the digital control signal into an analog control signal; and
a step of adjusting the reference voltage based on the analog control signal to converge the duty ratio of the demodulated signal to the target value.

14. The method of claim 9, wherein the sensing includes:
a step of, by a second charge amplifier, converting the driving displacement signal output from the gyro sensor into a voltage signal form;
a step of mixing, by a demodulator, an output signal from the second charge amplifier with the demodulated signal;
a step of removing, by a low pass filter, a high frequency component of an output signal from the demodulator; and
a step of converting an output signal from the filter into a digital value.
